(19) United States
(12) Patent Application Publication
(10) Pub. No.: US 2016/0356433 A1
(43) Pub. Date: Dec. 8, 2016

(54) LAMP MOUNTING STRUCTURE

(71) Applicant: DONGGUAN JIASHENG LIGHTING TECHNOLOGY CO. LTD, Dongguan City (CN)

(72) Inventor: Shuisheng XU, Dongguan City (CN)

(21) Appl. No.: 15/018,633

(22) Filed: Feb. 8, 2016

(30) Foreign Application Priority Data
Jun. 8, 2015 (CN) 201520390241.1

(51) Int. Cl. F21K 99/00; F21V 23/06

(52) U.S. Cl. CPC F21K 9/30; F21V 23/06

(57) ABSTRACT

A lamp mounting structure includes at least two tubes and LED modules each provided in each of the tubes, wherein each tube is connected to a first connector at one end and a second connector at the other end, the first and second connectors are able to couple with each other in a nesting manner; the first connector is provided with a first plug pin that is electrically connected to the LED module; and the second connector is provided with a plug-connection portion that is able to cooperate with the corresponding first plug pin and electrically connected to the LED module. The lamp mounting structure requires alignment and snap-fit engagement between the first connector of the first tube and the second connector of the second tube during installation by connecting two tubes.

### CROSS REFERENCE TO RELATED APPLICATIONS

This application claims priority under 35 U.S.C. §119(b) and 37 CFR 1.55 to Chinese application filed on Jun. 8, 2015, and having serial number CN 201520390241.1, wherein the entirety of said application is incorporated herein by reference.

### FIELD

The present disclosure relates to the field of illumination techniques, especially to a lamp mounting structure.

### BACKGROUND

Outdoor LED lamps nowadays are formed principally by connecting a PC shade, a LED module, a radiating tube, and a water-proof bulb. The LED module is fastened inside and illuminating through the PC shade. In practice, it is usually necessary to connect together and fasten multiple LED lamps usually before use. The current connecting means may be wire connection or adaptor connection. However, the connection wire is exposed, affecting the aesthetic appearance and suffering from aging in the long run, or even incurring a leaking problem in the threading hole of the connecting wire.

### SUMMARY OF THE INVENTION

Therefore, in one aspect of the present disclosure, a lamp mounting structure is provided to overcome the defects of the prior art and facilitate fast and convenient lamp mounting with neat appearance and minimum aging or leaking possibility, which is described below.

A lamp mounting structure is provided, which may comprise at least two tubes and LED modules each provided in each of the tubes, wherein each tube is connected to a first connector at one end and a second connector at the other end, the first and second connectors are able to couple with each other in a nesting manner; the first connector is provided with a first plug pin that is electrically connected to the LED module; and the second connector is provided with a plug-connection portion that is able to cooperate with the corresponding first plug pin and electrically connected to the LED module.

This aspect of the present disclosure will be discussed in further details below.

In one of the embodiments, an external fitting portion may be provided on the periphery of the first or second connector. The tube may be nested in a fixing sleeve that may be coupled with the external fitting portion. The fixing sleeve may be snap-fitted with the first or second connector.

In yet another embodiment, a seal ring may be provided between the first and second connectors.

In yet another embodiment, the first connector may be provided with at least one first annular nesting portion and the second connector may be provided with at least one second annular nesting portion that is able to cooperate with the first annular nesting portion.

In yet another embodiment, a wire outgoing joint may be further provided that may be coupled with the second connector in a nesting manner. The wire outgoing joint may be connected to a wire and a second plug pin. The second plug pin may be connected to the wire and coupled with the plug-connection portion.

In yet another embodiment, the wire outgoing joint may be provided with at least one third annular nesting portion that may be coupled with the second connector.

In yet another embodiment, an end cap may be further provided that may be coupled with the end of the lamp.

In yet another embodiment, a fixing structure may be further provided, wherein the fixing structure may comprise a fixing support and a snap ring. The fixing support, which may comprise an arched hoop surface that may be coupled with the tube, may be rotatably connected to the snap ring at one end and provided at the other end with a clasp portion that may be coupled with the snap ring.

In yet another embodiment, the fixing structure may further comprise a buckle that may be rotatably connected to the fixing support and the snap ring.

In yet another embodiment, each tube may be coupled with at least one fixing structure.

The mechanism and advantages of the technical solutions of the present disclosure described above will be discussed below.

The lamp mounting structure as described above requires alignment and snap-fit engagement between the first connector of the first tube and the second connector of the second tube during installation by connecting two tubes. The first plug pin of the first connector will engage with the plug-connection portion of the second connector to form electric conduction. As a result, a complete lamp can be formed with even LED modules of merely two tubes. The lamp mounting structure of the present disclosure is advantageously simple in structure and operation, with minimum leaking problem and optimal integrity.

### BRIEF DESCRIPTION OF THE DRAWINGS

FIG. 1 shows a schematic of an explosive view of the lamp mounting structure according to one embodiment of the present disclosure.

FIG. 2 shows a schematic of a sectional view of the lamp mounting structure according to one embodiment of the present disclosure.

FIG. 3 shows a structural schematic of the lamp mounting structure, according to one embodiment of the present disclosure, with the installation partially completed.

FIG. 4 shows a structural schematic of the lamp mounting structure according to another embodiment of the present disclosure.

FIG. 5 shows a sectional view of the lamp mounting structure according to one embodiment of the present disclosure.

FIG. 6 shows a structural schematic of the lamp mounting structure according to yet another embodiment of the present disclosure.

FIG. 7 shows a structural schematic of the fixing structure of the lamp mounting structure according to one embodiment of the present disclosure.

### REFERENCE SIGNS

10. tube; 12. first connector; 122. first plug pin; 124. external fitting portion; 126. first nesting portion; 14. second connector; 142. plug-connection portion; 144. second nesting portion; 15. wire outgoing joint; 152. wire; 154. second plug pin; 156. third nesting portion; 157. seal ring; 158. end cap; 16. fixing sleeve; 18. seal ring; 192.

fixing support; 194. snap ring; 195. arched hoop surface; 196. clasp portion; 197. buckle; 20. LED module.

### DETAILED DESCRIPTION OF PREFERRED EMBODIMENTS

Non-limiting examples for implementing the present application will be described in detail below.

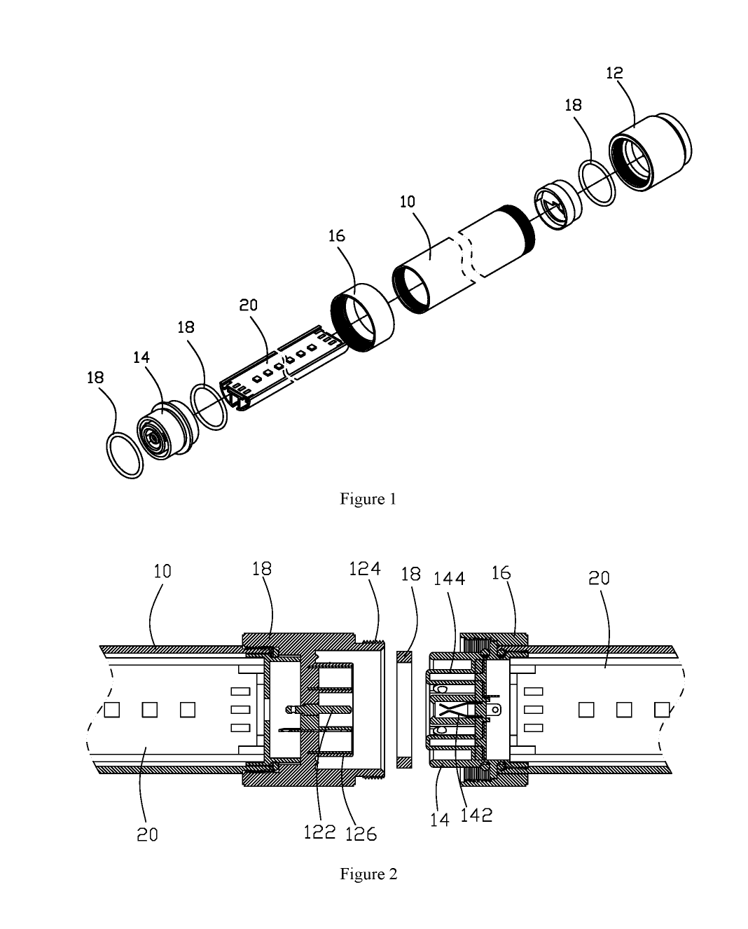

As shown in FIGS. 1 and 2, a lamp mounting structure is provided, which may comprise at least two tubes 10 and LED modules 20 each provided in each of the tubes 10. Each tube 10 may be connected to a first connector 12 at one end and a second connector 14 at the other end. The first and second connectors 12, 14 may be coupled with each other in a nesting manner. The first connector 12 may be provided with a first plug pin 122 that may be electrically connected to the LED module 20. The second connector may be provided with a plug-connection portion 142 that may be coupled with the first plug pin 122 and electrically connected to the LED module 20.

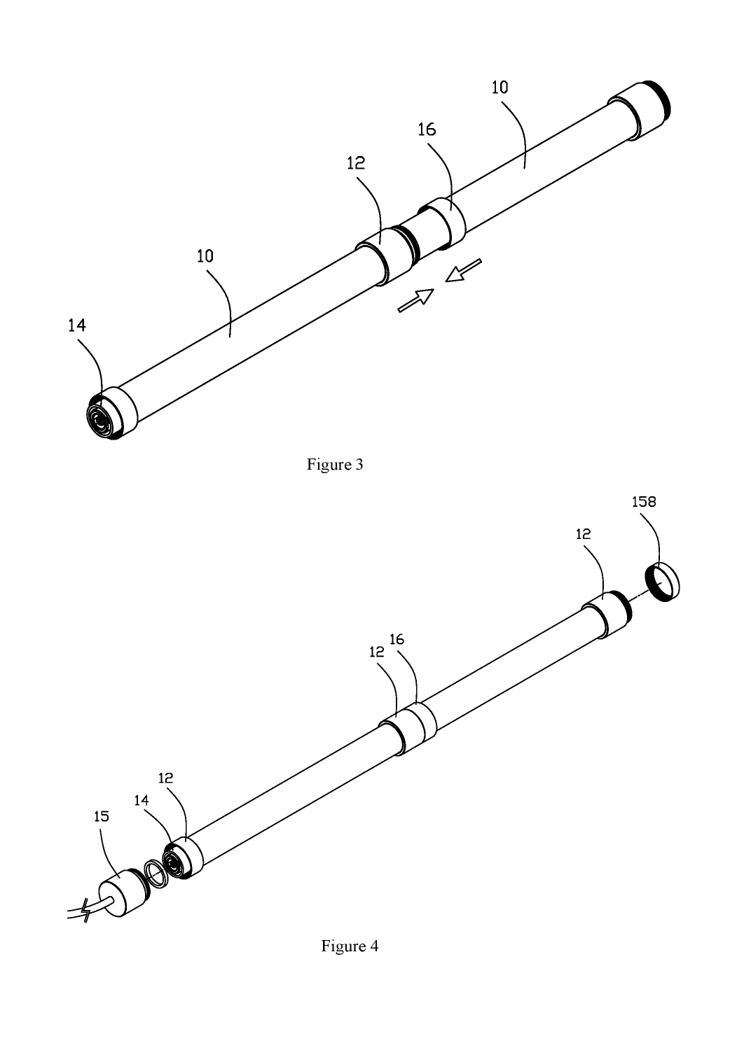

As shown in FIG. 3, the lamp mounting structure as described herein requires alignment and snap-fit nesting engagement between the first connector 12 of the first tube 10 and the second connector 14 of the second tube 10 during installation by connecting two tubes 10. The first plug pin 122 of the first connector 12 will engage with the plug-connection portion 142 of the second connector 14 to form electric conduction. As a result, a complete lamp can be formed with even LED modules 20 of merely two tubes 10. The lamp mounting structure of the present disclosure is advantageously simple in structure and operation, with minimum leaking problem and optimal integrity.

As shown in FIG. 2, an external fitting portion 124 may be provided on the periphery of the first connector 12. The tube 10 may be nested in a fixing sleeve 16 that may be coupled with the external fitting portion 124. The fixing sleeve 16 may be coupled with the first connector 12 in a snap-fit manner. In yet another embodiment, an external fitting portion may be provided on the periphery of the second connector 14. The corresponding fixing sleeve 16 may be coupled with the second connector 14 in a snap-fit manner. In this embodiment, the external fitting portion 124 and the fixing sleeve 16 are provided with a thread structure and a corresponding matching thread structure, respectively, which may be coupled with each other. The engagement between the first connector 12 or the second connector 14 and the tube 10 is in a thread fitting manner, simple in structure and easy for installation. The first connector 12 may be provided with at least one first annular nesting portion 126 and the second connector 14 may be provided with at least one second annular nesting portion 144. The first nesting portion 126 and the second nesting portion 144 are snap-fitted together after nesting. A seal ring 18 may be provided between the first nesting portion 126 and the second nesting portion 144 to prevent leaking.

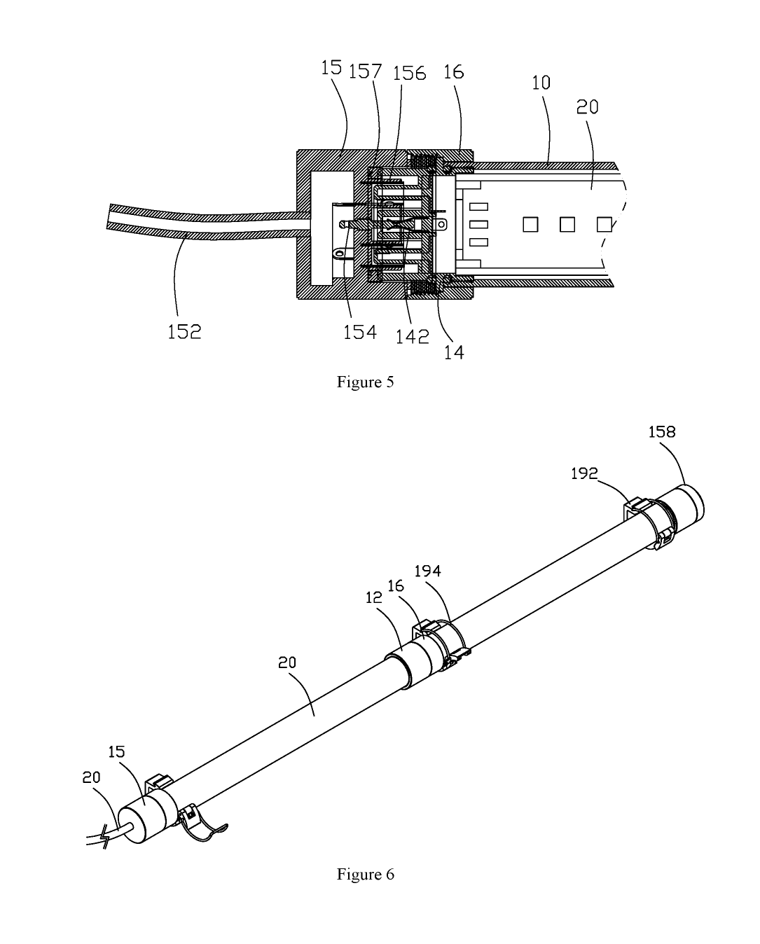

As shown in FIGS. 4 and 5, a wire outgoing joint 15 may be further provided in the lamp mounting structure. The wire outgoing joint 15 may be coupled with the second connector 14 in a nesting manner. The wire outgoing joint 15 may be connected to a wire 152 and a second plug pin 154. The second plug pin 154 may be connected to the wire 152 and also coupled with the plug-connection portion 142. In other words, a first connector 12 on one end of the first tube 10 is coupled with the second connector 14 of a second tube 10, a first connector 12 on the other end of the second tube 10 is coupled with the second connector 14 of a third tube 10, and so on. The second connector 14 on an end of this group of tubes 10 is coupled with the wire outgoing joint 15, resulting in conduction between the tube and the wire 152. Meanwhile, the first connector 12 on the other end of this group of tubes 10 is coupled with an end cap 158 to seal the tube.

The wire outgoing joint 15 may be provided with at least one third annular nesting portion 156 that may be coupled with the second connector 142. The coupling manner between the wire outgoing joint 15 and the second connector 142 is similar to that between the first connector 12 and the second connector 14. Similarly, a fixing sleeve 16 may be provided, fastened to the second connector 14 in a snap-fit manner and coupled with the first connector 12 in a thread-fitting manner. Additionally, a seal ring 157 is provided between the second nesting portion 144 and the third nesting portion 156 to prevent leaking.

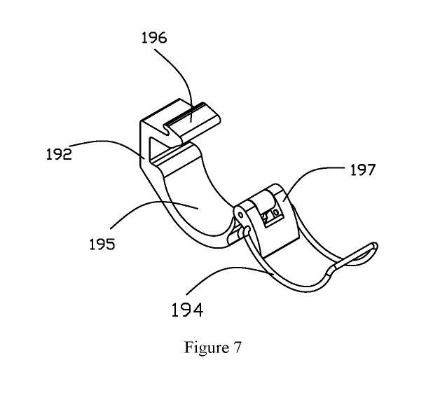

As shown in FIGS. 6 and 7, the lamp mounting structure may further comprise a fixing structure. The fixing structure may comprise a fixing support 192 and a snap ring 194. The fixing support 192, which may comprise an arched hoop surface 195 that may be coupled with the tube 10, may be rotatably connected to the snap ring 194 at one end and provided with a clasp portion 196 that may be coupled with the snap ring 194 at the other end. The fixing support 192 may be fixed to a wall or any other object, with the circular tube 10 bound to the arched hoop surface 195. The snap ring 194 may rotate and clasp in the clasp portion 196. Consequently, the tube 10 is fastened in the space defined by the fixing support 192 and the snap ring 194 and fixed to the wall or any other object by the fixing support 192. To ensure the stable fastening of the entire lamp, multiple fixing structures described herein may be used as desired. Preferably, the fixing structure is provided close to the end of the lamp at the joint of two tubes. Also preferably, it is ensured that each tube 10 is coupled with at least one such fixing structure.

The fixing structure may further comprise a buckle 197 that may be rotatably connected to the fixing support 192 and the snap ring 194. The buckle 197 may be pivotally connected to the fixing support 192. Similarly, the buckle 197 may be pivotally connected to the snap ring 194. Any other rotatable connection may also be used.

Individual technical feature in the embodiments above may be implemented in any combination. For conciseness, not all possible combinations of all the technical features are described herein. However, all such combinations without contradiction should be considered as within the scope of the application.

The detailed embodiments described herein are only for the purpose of illustrating the present disclosure, and are not intended to limit the scope of the present disclosure in any way. It would be understand by a person skilled in the art that various changes and modifications can be made to the embodiments described herein without departing from the scope and spirit of the present disclosure. Such changes and modifications are contemplated by the present disclosure, the scope of which should only be defined by the following claims.

1. A lamp mounting structure, comprising:
at least two tubes, and
LED modules each provided in each of the tubes,
wherein each tube is connected to a first connector at one end and a second connector at the other end, the first and second connectors are able to couple with each other in a nesting manner; the first connector is provided with a first plug pin that is electrically connected to the LED module; and the second connector is provided with a plug-connection portion that is able to cooperate with the corresponding first plug pin and electrically connected to the LED module.

2. The lamp mounting structure of claim 1, wherein an external fitting portion is provided on the periphery of the first or second connector; the tube is nested in a fixing sleeve that is able to couple with the external fitting portion; and the fixing sleeve is snap-fitted with the first or second connector.

3. The lamp mounting structure of claim 1, wherein a seal ring is provided between the first and second connectors.

4. The lamp mounting structure of claim 1, wherein the first connector is provided with at least one first annular nesting portion and the second connector is provided with at least one second annular nesting portion that is able to cooperate with the first annular nesting portion.

5. The lamp mounting structure of claim 4, further comprising a wire outgoing joint that is coupled with the second connector in a nesting manner, the wire outgoing joint is connected to a wire and a second plug pin that is connected to the wire and cooperates with the plug-connection portion.

6. The lamp mounting structure of claim 5, wherein the wire outgoing joint is provided with at least one third annular nesting portion that is coupled with the second connector.

7. The lamp mounting structure of claim 4, further comprising an end cap that is coupled with the end of the lamp.

8. The lamp mounting structure of claim 1, further comprising a fixing structure, wherein the fixing structure comprises a fixing support and a snap ring, wherein the fixing support, comprising an arched hoop surface that is coupled with the tube, is rotatably connected to the snap ring at one end and provided at the other end with a clasp portion that is able to couple with the snap ring.

9. The lamp mounting structure of claim 8, wherein the fixing structure further comprises a buckle that is rotatably connected to the fixing support and the snap ring.

10. The lamp mounting structure of claim 8, wherein each tube is coupled with at least one fixing structure.
